(19) United States
(12) Patent Application Publication
(10) Pub. No.: US 2013/0073338 A1
(43) Pub. Date: Mar. 21, 2013

(54) CUSTOMER INPUT APPLICATION

(71) Applicants: Kevin G. Kolpasky, Oakland Township, MI (US); Jim K. Rainbolt, Haslett, MI (US); Thomas Edward Howe, Brighton, MI (US); Jan H. Aase, Oakland Township, MI (US)

(72) Inventors: Kevin G. Kolpasky, Oakland Township, MI (US); Jim K. Rainbolt, Haslett, MI (US); Thomas Edward Howe, Brighton, MI (US); Jan H. Aase, Oakland Township, MI (US)

(73) Assignee: GM GLOBAL TECHNOLOGY OPERATIONS LLC, Detroit, MI (US)

(21) Appl. No.: 13/233,275

(22) Filed: Sep. 15, 2011

(51) Int. Cl. G06Q 10/00

(52) U.S. Cl. 705/7.32

(57) ABSTRACT

A method of submitting customer-identified insights for improving a fleet of vehicles. A capturing application is distributed that allows a customer to record a customer identified insight. The capturing application is configured to transmit a recorded customer-identified insight to a receiving unit. Customer-identified insights are received at the receiving unit via a communication system. The customer-identified insights are aggregated in a storage database. The customer-identified insights in the storage database are analyzed to identify potential vehicle improvements.

### BACKGROUND OF INVENTION

An embodiment relates generally to a vehicle improvement collaboration system.

Vehicles are produced with many accommodating features to the users of the vehicle. Such features typically are incorporated based on customer wants that are derived through market studies and trends. However, associated features of the vehicle are selected during the early design stages of the vehicle three to four years prior to the vehicle being on sale to the public. As a result, after the initial design stages and after the vehicle is in public and evaluated by the users, enhancements may become apparent to user regarding the features.

Vehicle designers and manufacturers are often interested in hearing what their customers have to say about the vehicle. In numerous instances, current, past, and potential future customers are selected to evaluate a vehicle and provide feedback relating to the vehicle and its features. Often the vehicle manufacturers are interested in hearing about enhancements that can be made to the vehicle to meet the customer's wants and improve satisfaction with the vehicle. Such feedback may be obtained from phone calls placed to the customers or surveys mailed to the customers. Response rates in such campaigns are usually low.

Customers during a course of ownership of a vehicle will often identify an enhancement that may improve the vehicle. However, such an insight may be thought of when the user is otherwise occupied and is not in a position to submit the insight to the vehicle manufacturer. Moreover, if a user receives a solicitation to provide feedback, it may come and the user may no longer remember the details pertaining to the improvement. Typically, the improvement and details are not recollected and submitted by the user. Moreover, a survey or request for suggestion often is provided to the user shortly after the purchasing the vehicle. If the user conceives an insight after the survey has been collected, then the insight will not get submitted to the vehicle manufacturer.

### SUMMARY OF INVENTION

An advantage of an embodiment is an immediate submission of a vehicle user's insight to an improvement of the vehicle. The user upon thinking of an enhancement to the vehicle can immediately document the enhancement using video and/or audio to submit to the vehicle manufacturer. This reduces the chances of the user having to recall the insight at a later time and omitting details of the improvement and reduces the chances of the user not submitting the insight to the vehicle manufacturer.

An embodiment contemplates a method of submitting customer-identified insights for improving a fleet of vehicles. A capturing application that allows a customer to record a customer identified insight is distributed. The capturing application is configured to transmit a recorded customer-identified insight to a receiving unit. Customer-identified insights are received at the receiving unit via a communication system. The customer-identified insights are aggregated in a storage database. The customer-identified insights are analyzed in the storage database to identify potential vehicle improvements.

An embodiment contemplates a collaboration system for improving vehicles. A plurality of recording modules record customer-identified insights. Each recording module is associated with a respective one of the vehicles. A centralized database module collects recorded customer-identified insights from a plurality of recording modules via a communication system. A sharing module extracts information from the collected recorded customer-identified insights in response to user queries associated with efforts by users to identify potential improvements to the vehicles.

### BRIEF DESCRIPTION OF DRAWINGS

FIG. 1 is a block diagram of a collaboration system.

FIG. 2 is an exemplary illustration of a recording module in initial execution stage.

FIG. 3 is an exemplary illustration of the recording module in a preference input stage.

FIG. 4 is an exemplary illustration of the recording module in the transmission stage.

FIG. 5 is a block flow diagram for submitting the customer-identified insight to the base entity.

### DETAILED DESCRIPTION

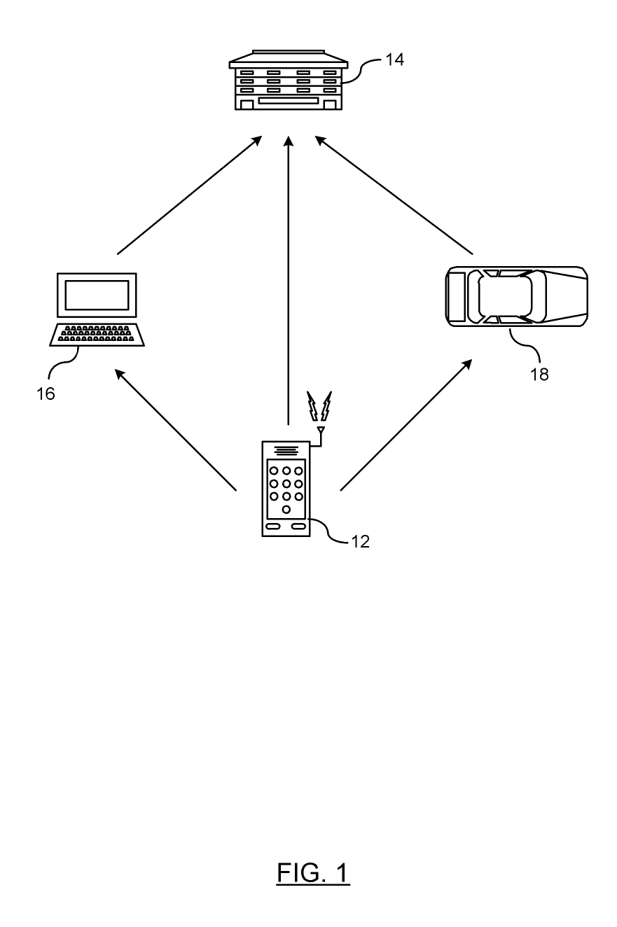

There is shown in FIG. 1 a block diagram of a collaboration system 10. The collaboration system 10 is used to identify insights identified by customers for improving a fleet of vehicles.

The collaboration system 10 includes a recording module 12 in communication with a base entity 14. The recording module 12 includes a capturing application that allows a customer to record customer identified insights. The recording module 12 is any device that is capable of recording media content such as video and/or audio. The multimedia device 12 may include, but is not limited to, portable devices such as smartphones and PDAs, or may be a vehicle-installed video or audio recording device within the vehicle. The capturing application is configured to transmit the recorded insight to a receiving unit. The receiving unit may be the base entity 14 or may be an intermediate receiving unit, such as vehicle module 16 or a computer 18 that is in communication with the base entity 14.

The vehicle module 16 may be a communication service such as OnStar® where the recorded customer-identified insight captured by the recording device 12 is communicated to the base entity 14 via OnStar®.

The computer 18 may be used to download the recorded customer-identified insight captured by the recording device 12 and transmit the recorded customer-identified insight to the base entity 14 via the internet. In this example, the computer 18 may be used strictly as a communication link or a capturing application may be loaded onto the computer which guides the user in downloading the captured media and inputting the necessary information for transmitting to the base entity 14.

The recording module 12 may be an in-vehicle supplied device wherein the capturing application is already installed such as an in-vehicle camera, or may be a personal portable device owned by that user wherein the capturing application is distributed by or on behalf of the vehicle manufacturer (e.g., via the android market) and added by the user onto their device.

The recording module 12 allows a user to capture an idea or other insight that can be used to modify the vehicle for improving a feature or characteristic of the vehicle. For example, a user may have an idea of how something may be better secured to bed of a truck. The user can utilize the recording module 12 to record a video of the idea and also provide narration of the captured insight event. The idea can relate to a new feature for improving the vehicle or may be an existing feature that would require modification of a component. The advantage is that the event may be captured at the time when idea is fresh in the user's mind as opposed to recollecting the event at a later time. The insight may relate to matters that include, but are not limited to design issues, manufacturing issues, assembly issues, or other quality issues that a user desires to convey a vehicle manufacturer or other responsible party.

A base entity 14 includes a centralized database module and a sharing module. The centralized database module collects recorded customer-identified insight suggestions transmitted by the user over a communication system. The communication system may be a wireless system, a wireline system, or a combination of both wireless and wireline. The recorded customer-identified insights are stored in the central database module until they are analyzed by authorized personnel.

The sharing module extracts information from the recorded customer-identified insights collected in the centralized database module based on queries from the authorized personnel. The information can be extracted based on inputs by the user prior to transmitting the customer-identified insight. The audio from the customer-identified insight can be converted from audio to text and the query can be searched based on the text.

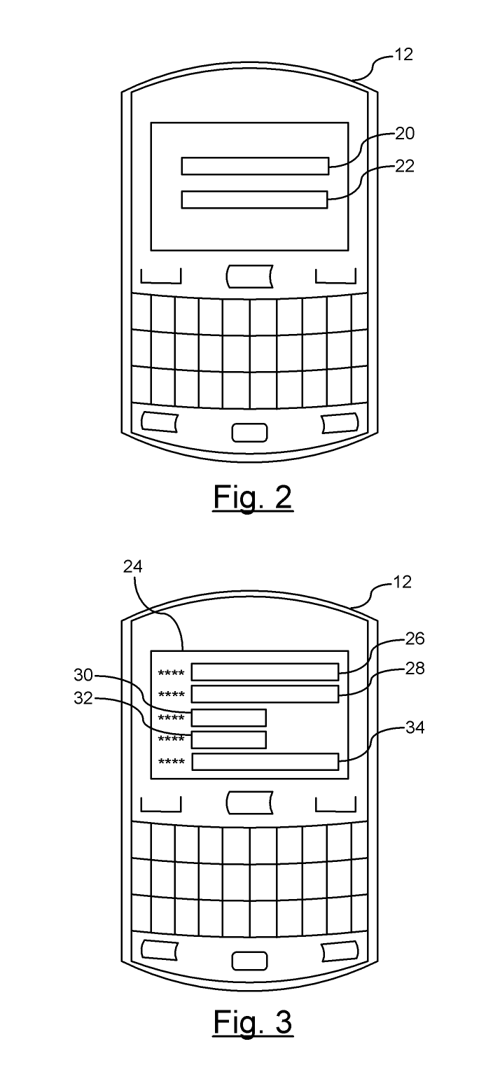

The capture application may be an already-installed application that is provided on an in-vehicle recording module or may be a downloadable application that may be installed on a portable device (e.g., smartphone), or a computer. FIG. 2 illustrates an example of a recording module that includes the capture application. When initiated, a set of selections is provided to the user for executing a program for submitting the customer-identified insight. In the illustration shown, a smartphone that includes touchscreen controls and a video capture device is utilized. A first selection “Begin Recording” is identified generally at 20, and a second selection “Edit Preferences” is identified generally at 22. Begin Recording selection 20 initiates the recording of the customer-identified insight. The user can stop the recording when complete and save the recorded event at any time or the recording time may be limited to a predetermined maximum amount of time (e.g., 30 seconds). The user may also provide narration along with the captured video to better enhance the understanding of the customer-identified insight captured in the recording. Alternatively, the customer-identified insight may be transmitted as a still picture with audio or may only include audio. The advantage is that the user can capture the customer-identified insight immediately at a time when the idea is fresh in ones mind as opposed to recollecting the idea at a later date.

The second selection “Edit Preferences” 22 allows the user to identify self-characteristics about oneself for the purposes of querying the customer-identified insight to a selected group of people. When a respective customer-identified insight is transmitted to the base entity 14, user-identification data entered with the preferences screen is additionally transmitted. FIG. 3 illustrates a user identification preference screen 24 displayed on the recording module 12. The user identification preference screen 24 allows a user to enter the following information that includes, but is not limited to, a user's name 26, a user's email address 28, a user's age 30, a user's gender 32, and a user's occupation 34. Preference data may be used to conduct inquiries or may be used to contact the user for further information and discussion relating to their insights.

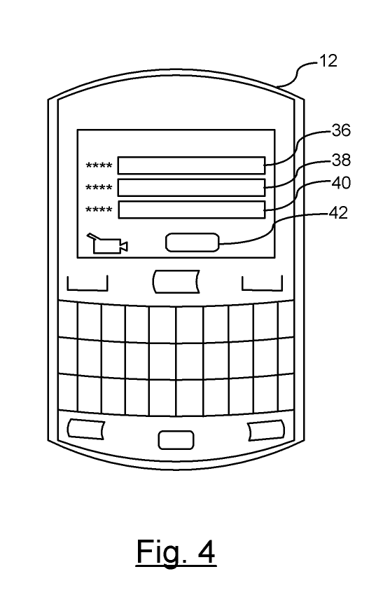

FIG. 4 illustrates additional information that may be transmitted to the base entity 14. Such information includes, but is not limited to, a vehicle make 36, a vehicle model 38, and a vehicle model year 40. The user identification preferences are saved permanently within the recording module until edited or deleted.

In FIG. 4, the capturing application displays a “Send” option 42 which will transmit the customer-identified insights to the base entity 14 along with any preference data appended to the captured recordings.

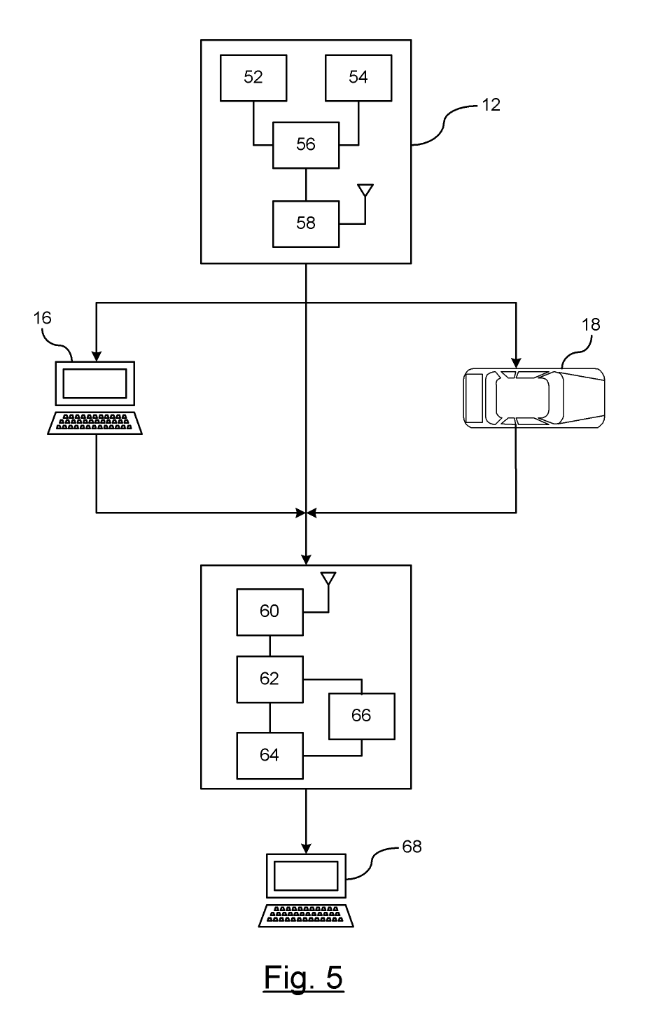

FIG. 5 illustrates a block flow diagram for submitting the customer-identified insight to the base entity. The recording module 12 includes a video capture subcomponent 52 and an audio capture subcomponent 54. It should be understood that the video capture subcomponent 52 and the audio capture subcomponent 54 may be integrated as a single unit.

A capture application 56 is installed within the recording module 12 that provides the application tools and protocol for initiating the recording of the customer-identified insight. The application tools also allow for the user to enter user preference data and any other additional information. The capture application also controls the transmission of the recorded customer-identified insight along with the preference data.

The customer-identified insight message is transmitted via a transmitter 58 either directly to the base entity 14 or to an intermediate communication device. An intermediate communication device may include a computer 16 that accesses and communicates with the base entity 14 via the web. An intermediate communication device may also include vehicle based communication system 18, such as OnStar®, which is a subscription-based communications service currently provided on vehicles manufactured by General Motors.

The base entity 14 includes a receiver 60 for receiving the recorded customer-identified insight suggestions. The base entity 14 further includes a centralized database module 62 and a sharing module 64. The centralized database module 62 collects recorded customer-identified insight suggestions transmitted from the recording module 12 over a communication system. The communication system may be a wireless system, a wireline system, or a combination of both wireless and wireline. The recorded customer-identified insight suggestions are stored in the centralized database module 62 until the insights are analyzed by authorized personnel.

The sharing module 64 extracts information from the recorded customer-identified insights collected in the centralized database module 62 based on queries from the authorized personnel. The information can be extracted based on parameters and other inputs entered by the user prior to transmitting the customer-identified insight suggestion.

The based entity 14 may also include an audio-to-text conversion module 66 for converting the audio of in the customer-identified insight suggestion to text. Queries for specific keywords or phrases may be searched based on the text from the converted audio. Queries are executed from a computer 68 or other processing device (e.g., query generating module) by the authorized personnel.

The base entity 14 may also disseminate the received customer-identified insight suggestions to other users, such as those users owning like vehicles, for evaluating and providing their input on the respective customer-identified insight suggestion. By disseminating the customer-identified insight suggestions to other users, current insights may trigger user to provide additional enhancements to the current insight. For example, if a first user's insight is disseminated to a second user of a similar vehicle, the insight may either stimulate another user to generate an enhancement of the current insight, or another user may already have a more enhanced insight, but was not motivated to submit the respective insight. Therefore, seeing that an insight is already submitted may motivate the second user to submit their insight if the second user feels that their insight improves upon the current insight.

It should be understood that the authorized personnel can randomly view customer-identified insights from the centralized database without generating any query. The insights are then used by the authorized personnel to evaluate the feasibility of the insight and determine whether modifications can be made to the vehicle. If modifications are feasible, then improvements to the vehicle may be used to improve the vehicle.

While certain embodiments of the present invention have been described in detail, those familiar with the art to which this invention relates will recognize various alternative designs and embodiments for practicing the invention as defined by the following claims.

1. A method of submitting customer-identified insights for improving a fleet of vehicles, the method comprising the steps of:
distributing a capturing application to a customer that allows the customer using a vehicle to record a customer identified insight by a recording device, the customer identified insight is an idea by the customer for improving a feature of the vehicle, the capturing application transmits a recorded customer-identified insight to a receiving unit;
receiving customer-identified insights at the receiving unit via a communication system;
aggregating the customer-identified insights in a storage database unit; and
analyzing the customer-identified insights in the storage database unit by a responsible entity of a vehicle manufacturer to identify potential vehicle improvements.

2. The method of claim 1 wherein the capturing application is installed on a recording device, wherein the capturing application provides a protocol for capturing the customer-identified insights and transmitting the customer-identified insights to a receiving unit.

3. The method of claim 1 wherein aggregating the customer-identified insights in the storage database unit includes categorizing and archiving the customer-identified insights.

4. The method of claim 1 wherein preference data is received with the customer-identified insights, the preference data including user-related information and vehicle-related information.

5. The A method of claim 4 wherein analyzing the customer-identified insights includes executing a query for specific customer-identified insights utilizing the preference data.

6. The method of claim 4 wherein the customer identified insights includes recorded video.

7. The method of claim 4 wherein the customer identified insights includes recorded audio.

8. The method of claim 7 wherein the recorded audio is converted from speech to text.

9. The method of claim 8 wherein analyzing the customer-identified insights includes executing a query for specific the customer-identified insights utilizing the text.

10. A collaboration system for improving vehicles, the system comprising:
a plurality of recording devices for recording customer-identified insights, each recording device associated with a respective one of the vehicles, the customer-identified insight is an idea by a user of the vehicle for improving a vehicle feature of the vehicle;
a centralized database unit for collecting recorded customer-identified insights from a plurality of recording devices;
a communication system for transmitting customer insights between the plurality of recording devices and a receiving unit, the centralized database being associated with the unit receiving unit for collecting the customer identified insight; and
a sharing module for extracting information from the customer-identified insights collected in the centralized database unit in response to user queries associated with efforts by users to identify potential improvements to the vehicles, the queries being executed by a responsible entity of a vehicle manufacturer.

11. The collaboration system of claim 10 wherein the recording device includes a video recording component for capturing video of the customer-identified insights.

12. The collaboration system of claim 10 wherein the recording device includes an audio recording component for capturing narration from a user relating to the customer-identified insights.

13. The collaboration system of claim 10 wherein the recording device includes a capturing application, wherein the capturing application provides a protocol for capturing the customer-identified insights and transmitting the customer-identified insights to a the receiving unit associated with the centralized database unit.

14. The collaboration system of claim 10 wherein the communication system includes a vehicle-based communication system for receiving the customer-identified insights from the recording device and transmitting the customer-identified insights to the centralized database unit.

15. The collaboration system of claim 10 wherein the communication system includes an internet based system for receiving the customer-identified insights from the recording module device and transmitting the customer-identified insights to the centralized database unit.

16. The collaboration system of claim 10 wherein the sharing module includes a server for categorizing the customer-identified insights based on preference data.

17. The collaboration system of claim 10 further comprising a speech-to-text module for converting audio transmitted with the customer-identified insights to text, wherein the sharing module identifies the vehicle concepts and categorizes the customer-identified insights utilizing the text.

18. The collaboration system of claim 10 wherein the sharing module is used to disseminate customer-identified insights to a plurality of users of a particular model of vehicle.

19. The collaboration system of claim of claim 10 further comprising a query generating module in communication with the sharing module, wherein inputs entered from an authorized personnel are searched within the centralized database unit for generating a group of customer-identified insights relating to a vehicle concept.

20. The collaboration system of claim of claim 10 wherein the recording device includes a smartphone.

21. The collaboration system of claim 10 wherein the sharing module includes a vehicle-installed device.
